(19) United States
(12) Patent Application Publication
(10) Pub. No.: US 2021/0204549 A1
(43) Pub. Date: Jul. 8, 2021

(54) BACILLUS AMYLOLIQUEFACIENS AND NEONICOTINOIDS MIXTURES AND METHODS OF USE THEREOF

(71) Applicant: Valent U.S.A. LLC, San Ramon, CA (US)

(72) Inventor: Hunt Sanders, Tifton, GA (US)

(21) Appl. No.: 17/137,985

(22) Filed: Dec. 30, 2020

Related U.S. Application Data
(60) Provisional application No. 62/956,706, filed on Jan. 3, 2020.

(51) Int. Cl. A01N 63/22; A01N 51/00

(52) U.S. Cl. CPC A01N 63/22; A01N 51/00

(57) ABSTRACT

The present invention is directed to pesticidal mixtures containing Bacillus amyloliquefaciens and one or more neonicotinoids. The present invention further relates to methods of controlling a pest by applying Bacillus amyloliquefaciens and one or more neonicotinoids to a plant, plant propagation material or an area where a plant will grow.

### FIELD OF THE INVENTION

The present invention is directed to pesticidal mixtures containing Bacillus amyloliquefaciens and one or more neonicotinoids. The present invention further relates to methods of controlling a pest by applying Bacillus amyloliquefaciens and one or more neonicotinoids to a plant, plant propagation material or an area where a plant will grow.

### BACKGROUND OF THE INVENTION

Tomato spotted wilt virus (“TSWV”) is the cause of serious disease in many economically important plants including peanut plants and tobacco plants. Prevention of TSWV has been well studied since the discovery of the disease in peanut plants in the early 1990's. Many chemicals agents have been tested and a partial list of compounds and trials directed to control of TSWV is set forth in Plant Disease Management Reports.

TSWV has typically been controlled in peanuts by planting date, seeding rate, the use of resistant cultivars, and the insecticide Thimet® (phorate). Although phorate helps control the TSWV vector, tobacco thrips, it is a host plant defense response which is induced by phorate that prevents TSWV. This response has been well documented in the literature. Disadvantages of the current TSWV control methods include: 1) planting date recommendations typically have a narrow window when TSWV risk is low (i.e. 15 days) and most growers cannot get all their crops planted in this window; 2) seeding rates used to prevent TSWV are higher than what growers would use if TSWV wasn't a problem; 3) phorate causes phytotoxicity in peanuts; 4) control by phorate is not always acceptable; 5) there are grazing restrictions with phorate; and 6) the most widely used resistant cultivar (GA-06G) still requires the use of phorate in at risk situations. Further, there are no known ways to control TSWV once the crop has been planted and the plant is infected.

Accordingly, there is a need in the art for compositions and mixtures for the prevention of TSWV.

### SUMMARY OF THE INVENTION

The present invention is directed to a pesticidal mixture of Bacillus amyloliquefaciens and one or more neonicotinoids.

The present invention is further directed to a method of controlling a pest comprising applying a pesticidal mixture of the present invention to a plant, plant propagation material or an area where a plant will grow.

The present invention is further directed to a method of controlling tomato spotted wilt virus applying a pesticidal mixture comprising an effective amount of Bacillus amyloliquefaciens and imidacloprid to a plant, plant propagation material or an area where a plant will grow.

### DETAILED DESCRIPTION OF THE INVENTION

The Applicant has unexpectedly discovered that a mixture of Bacillus amyloliquefaciens and one or more neonicotinoids are more effective in controlling tomato spotted wilt virus than the commercial standard, phorate. Further, the Applicant has unexpectedly discovered that a mixture of Bacillus amyloliquefaciens and one or more neonicotinoids is capable of controlling tomato spotted wilt virus after the virus infects the plant.

As used herein, the term “plant propagation material” refers to seeds and seedlings of all kinds (fruit, tubers, and grains), clonal and micro propagated plants, and the like.

As used herein, “improving” means that the plant has more of the specific quality than the plant would have had it if it had not been treated by methods of the present invention.

As used herein, “to control” a pest or “controlling” pest(s) refers to killing, incapacitating, repelling, or otherwise decreasing the negative impact of the pest on plants or animals to a level that is desirable to the grower, applicator or user.

The term “effective amount” means the amount of the formulation that will control the target pest. The “effective amount” will vary depending on the mixture concentration, the type of pest(s) being treated, the severity of the pest infestation, the result desired, and the life stage of the pest during treatment, among other factors. Thus, it is not always possible to specify an exact “effective amount.” However, an appropriate “effective amount” in any individual case may be determined by one of ordinary skill in the art.

The articles “a,” “an” and “the” are intended to include the plural as well as the singular, unless the context clearly indicates otherwise. For example, the methods of the present invention are directed to controlling “pest” but this can include control of a multiple pests (such as a more than one insect or more than one insect species or more than one mite or more than one mite species.

As used herein, all numerical values relating to amounts, ratios, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

In one embodiment, the present invention is directed to a pesticidal mixture comprising an effective amount of Bacillus amyloliquefaciens and one or more neonicotinoids.

Neonicotinoids suitable for use in the present invention include, but are not limited to, imidacloprid, dinotefuran, clothianidin, acetamiprid, thiamethoxam, thiacloprid and mixtures thereof. In a preferred embodiment the one or more neonicotinoids is imidacloprid.

In a preferred embodiment, the strain of B. amyloliquefaciens is PTA-4838.

In a preferred embodiment, Bacillus amyloliquefaciens and the one or more neonicotinoids may be present in mixtures of the present invention at a weight ratio of from about 2:1 to about 1,000:1, preferably from about 10:1 to about 500:1, more preferably from about 20:1 to about 200:1, even more preferably from about 32:1 to about 177:1 and most preferably at about 31.5:1 or about 177:1.

In another embodiment, mixtures of the present invention further comprise one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

The formulations of the present invention can be applied by any convenient means. Those skilled in the art are familiar with the modes of application that include foliar applications such as spraying and soil applications including spraying, in-furrow treatments, or side-dressing.

Formulations of the present invention may be applied to any plant or plant propagation material thereof that may benefit from improved growth including agricultural crops, annual grasses, trees, shrubs, ornamental flowers and the like. Formulations of the present invention may further be applied to any area where a plant will grow including soil, a plant root zone and a furrow.

In another embodiment the present invention is further directed to a method of improving plant growth comprising applying mixtures of the present invention to a plant, plant propagation material or an area where a plant will grow.

In another embodiment the present invention is further directed to a method of controlling a pest applying mixtures of the present invention to a plant, plant propagation material or an area where a plant will grow.

In a preferred embodiment, the area where a plant will grow includes corn fields, cotton fields, peanut fields and soybean fields. In a more preferred embodiment, the area where a plant will grow includes corn fields, cotton fields and peanut fields.

In a preferred embodiment the area where a plant will grow is soil or a plant root zone.

In a more preferred embodiment, the soil is in the form of a furrow.

In another preferred embodiment, the pest is a virus, more preferably tomato spotted wilt virus.

In a more preferred embodiment, the present invention is directed to a method of controlling tomato spotted wilt virus applying a pesticidal mixture comprising an effective amount of Bacillus amyloliquefaciens and one or more neonicotinoids to a plant, plant propagation material or an area where a plant will grow.

In another preferred embodiment, the Bacillus amyloliquefaciens may be applied at a rate of from about 0.1 to about 100 grams per hectare (“g/HA”), more preferably from about 0.1 to about 50 g/HA, even more preferably from about 1 to about 10 g/HA and most preferably at about 1.44 g/HA or about 8.09 g/HA.

In another preferred embodiment, the one or more neonicotinoids may be applied at a rate of from about 1 to about 500 g/HA, more preferably from about 100 to about 400 g/HA, even more preferably from about 200 to about 300 g/HA and most preferably at 254.85 g/HA or 255 g/HA.

These representative embodiments are in no way limiting and are described solely to illustrate some aspects of the invention.

Further, the following example is offered by way of illustration only and not by way of limitation.

### EXAMPLES

Aveo® EZ was used as the source of B. amyloliquefaciens and is a registered trademark of and available from Valent U.S.A. LLC. Aveo® EZ contains 16.5% B. amyloliquefaciens.

Admire® Pro was used as the source of imidacloprid and is a registered trademark of and available from Bayer CropScience LP. Admire® Pro contains 42.8% imidacloprid.

### Example 1—Efficacy of B. amyloliquefaciens and Imidacloprid Mixture on Tomato Spotted Wilt Virus

### Method

The following greenhouse test was conducted from May 31, 2018 to Oct. 22, 2018 in Tift County, Georgia. Peanut plants (Arachis hypogaea) were used in the test as the crop plant. 6 seeds were planted per foot per row giving 360 seeds per plot. The peanut plants were infected with tomato spotted wilt virus (“TSWV”).

Furrows were sprayed with B. amyloliquefaciens strain PTA-4838, imidacloprid, fluopyram and/or Mycorrhizae consortium at the rates disclosed in Table 1 prior to seedling plating. The plants were then infected with TSWV. Number of live plants were counted at 63 days after treatment. Percent TSWV infection was calculated as percent of row feet infected per plot. Results can be found in Table 1, below. All data was analyzed using Bartlett's test and with p value of 0.5 for determining significance of the results.

### Results

As seen in Table 1, below, a mixture of B. amyloliquefaciens strain PTA-4838 and imidacloprid provided superior control of TSWV compared to imidacloprid alone. This Further, the addition of mycorrhizae consortium to the mixture of B. amyloliquefaciens strain PTA-4838 and imidacloprid nor the addition of fluopyram to imidacloprid increased the control of TSWV.

TABLE 1

| | Application Rate | |
|---|---|---|
| Treatment | g/HA | % Control |
| Imidacloprid | 254.85 | 96.4a |
| B. amyloliquefaciens PTA-4838 | 1.44 | 99.2b |
| Imidacloprid | 254.85 | |
| B. amyloliquefaciens PTA-4838 | 8.09 | 98.4b |
| Imidacloprid | 254.85 | |
| B. amyloliquefaciens PTA-4838 | 1.44 | 99.2b |
| Imidacloprid | 254.85 | |
| Mycorrhizae Consortium | 140.11 | |
| Fluopyram | 194.19 | 96.4a |
| Imidacloprid | 279.93 | |

What is claimed is:

1. A pesticidal mixture comprising an effective amount of Bacillus amyloliquefaciens and one or more neonicotinoids.

2. The mixture of claim 1, wherein the ratio of Bacillus amyloliquefaciens to one or more neonicotinoids is from about 2:1 to about 1,000:1.

3. The mixture of claim 1, wherein the ratio of Bacillus amyloliquefaciens to one or more neonicotinoids is from about 10:1 to about 500:1.

4. The mixture of claim 1, wherein the ratio of Bacillus amyloliquefaciens to one or more neonicotinoids is from about 20:1 to about 200:1.

5. The mixture of claim 1, wherein the ratio of Bacillus amyloliquefaciens to one or more neonicotinoids is from about 32:1 to about 177:1.

6. The mixture of claim 1, further comprising one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

7. A pesticidal mixture comprising an effective amount of Bacillus amyloliquefaciens and imidacloprid.

8. A method of controlling a pest comprising applying a pesticidal mixture comprising an effective amount of Bacillus amyloliquefaciens and one more neonicotinoids to a plant, plant propagation material or an area where a plant will grow.

9. The method of claim 8, wherein the one or more neonicotinoids is imidacloprid.

10. The method of claim 8, wherein the pest is a virus.

11. The method of claim 8, wherein the pest is tomato spotted wilt virus.

12. The method of claim 8, wherein the mixture is applied an area where a plant will grow.

13. The method of claim 12, wherein the area where a plant will grow is soil.

14. The method of claim 13, wherein the soil is in the form of a furrow.

15. The method of claim 12, wherein the area where a plant will grow is a plant root zone.

16. The method of claim 8, wherein the Bacillus amyloliquefaciens is applied at a rate of from about 0.1 to about 100 grams per hectare.

17. The method of claim 8, wherein the Bacillus amyloliquefaciens is applied at a rate of from about 1 to about 10 grams per hectare.

18. The method of claim 8, wherein the one more neonicotinoids is applied at a rate of from about 1 to about 500 grams per hectare.

19. The method of claim 8, wherein the one more neonicotinoids is applied at a rate of from about 200 to about 300 grams per hectare.

20. The method of claim 8, wherein the one more neonicotinoids is applied at a rate of about 255 grams per hectare.
